(19) United States
(12) Patent Application Publication
(10) Pub. No.: US 2014/0201291 A1
(43) Pub. Date: Jul. 17, 2014

(54) System and Method for Creating a Geographically-Defined Social Network

(71) Applicant: Long Russell, San Francisco, CA (US)

(72) Inventor: Long Russell, San Francisco, CA (US)

(21) Appl. No.: 13/742,962

(22) Filed: Jan. 16, 2013

(51) Int. Cl. H04L 29/08

(52) U.S. Cl. CPC H04L 67/22
USPC 709/206; 709/204

(57) ABSTRACT

A system and method for creating a geographically-defined social network. In the preferred embodiment, residents living in a defined geographical area, such as a particular neighborhood, are connected to one another via a social network. Membership in the social network is determined based on geographical location. Also in the preferred embodiment, residents in the defined geographical area can communicate with each other, but not with residents in other defined geographical areas. Communication can be by messaging, email, phone, or other communications methods. In another embodiment, businesses can communicate with residents within a geographical region.

### FIELD

The present disclosure relates generally to social networking and more particularly, but not exclusively, to systems and methods for creating social networks in defined geographical regions.

### BACKGROUND

Numerous types of social networks exist to allow a person to communicate with others who share similar interests or with whom a person has a relationship.

In a traditional social network, a user creates a profile, including information about the user, commentary from the user, and oftentimes photographs, movies, and other media either created by the user or linked by the user. The user then uses the social networking system to connect with others who have also created profiles on the social network.

In many social networks, most of the connections, at least initially, are made between people who already have some sort of relationship—friends, classmates, coworkers, etc. Over time, the network can expand to include newly-met people, or people who are friends of friends. Introductions and meetings can be conducted entirely within the social networking engine.

In other social networks, connections are made based on shared interests. Users can search profiles for users who share common interests, or common hobbies, and create a network of connections that are based not on a relationship, but on a shared interest. Over time, generally some of these connections will become relationship-based.

In yet other social networks, connections are made based on business relationships. Colleagues and coworkers can introduce people in their networks to other people in their networks who might otherwise never have met.

Although any given social networking platform will generally have one of the above models as its primary method of making initial connections, nearly all social networking platforms have some elements of each of the above models. Because of the social aspects of social networking, people who initially connect for business, for example, may find that they have other interests in common, such as a common hobby. Likewise, people who initially connect because of a personal relationship may later find themselves creating business connections as well.

Existing social networks also allow a user some ability to integrate geography into the social networking experience. For example, some social networks allow a user to “check in” where they are located, either manually or by using mobile devices that have the ability to determine a user's location. Such “check-ins” can advertise to a user's connections the user's real-time location, enabling a user and his connections to meet or to recommend a nearby restaurant, for example.

However, what none of these existing social networking models have is a way to replicate neighborhoods—that is, connections between people based not on personal relationships, or business relationships, or shared interests, but based simply on geographical proximity. The present disclosure presents a social networking system and method designed to connect those within a geographical community.

### BRIEF DESCRIPTION OF THE DRAWINGS

Further features, characteristics and advantages of the present invention will become apparent to a person of ordinary skill in the art from the following detailed description of preferred embodiments of the present invention, made with reference to the annexed drawings, in which like reference characters refer to like elements and features, and in which:

FIG. 1 illustrates a general overview of a generic social network.

FIG. 2 illustrates a general overview of a neighborhood social network

FIG. 3 is a flow chart illustrating the general use of an embodiment of a neighborhood social network in accordance with the present invention.

FIG. 4 is an exemplary top-level flow chart illustrating operation of an embodiment of a neighborhood social network in accordance with the present invention.

FIG. 5 is an exemplary flow chart illustrating operation of an embodiment of a neighborhood social network of FIG. 4.

FIG. 6 is an exemplary flow chart illustrating operation of an embodiment of a neighborhood social network of FIG. 4.

FIG. 7 illustrates differences between residential users and business users.

FIG. 8 is an exemplary flow chart illustrating operation of an embodiment of a neighborhood social network of FIG. 7.

### DETAILED DESCRIPTION

A system and method for creating a geographically-defined social network is disclosed herein. In a preferred embodiment, a geographical region is defined, and a user of the social network located within the defined geographical region can then use the social network to communicate with another user located within the defined geographical region. Preferably the geographical region is a neighborhood or other area with established boundaries, but may be any region of limited geographic scope.

In the preferred embodiment, the communication facilitated by the social network is email. In another embodiment, the communication is a SMS (Short Message Service) message, or text. In yet another embodiment, the communication is via a messaging system managed by the social network itself. In another embodiment, the communication between users is by telephone or cellular phone. Any other form of communication, including Twitter, paging, etc., could also be implemented.

In another embodiment, the geographical region is defined as a number of city blocks. In another embodiment, the geographical region is defined by a circle of a specific radius with a specific center. In another embodiment, the geographical region is of an arbitrary size and shape.

In another embodiment, the location of the users of the social network is the users' residences.

In another embodiment, instead of a single defined geographical region, multiple geographic areas are defined. A user in a particular defined geographical region can communicate via the social network with a user in a different defined geographical region so long as both users are also within the defined geographical region of the other.

In another embodiment, each user is at the center of a particular defined geographical region. The particular defined geographical region can be a number of city blocks, a circle with a specific radius, or a region of arbitrary size and shape.

In another embodiment, the defined geographical region is fixed. In another embodiment, the defined geographical region can be resized.

In another embodiment, there are two types of users of the social network—residents and businesses.

Further, the disclosed methods can comprise a series of software instructions, stored on a computer-readable medium and executable by a processor.

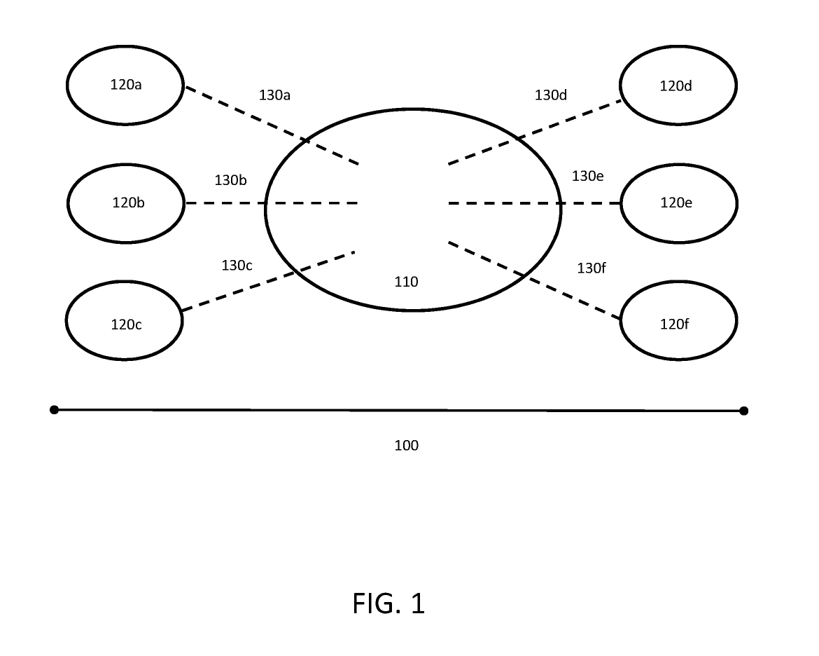

FIG. 1 details a basic method for implementing a standard social network 100. Social network 100 includes the social networking service 110, users 120a-f, and connections 130a-f. Each user 120a-f can communicate with one or more users 120a-f via connections 130a-f mediated by the social networking service 110.

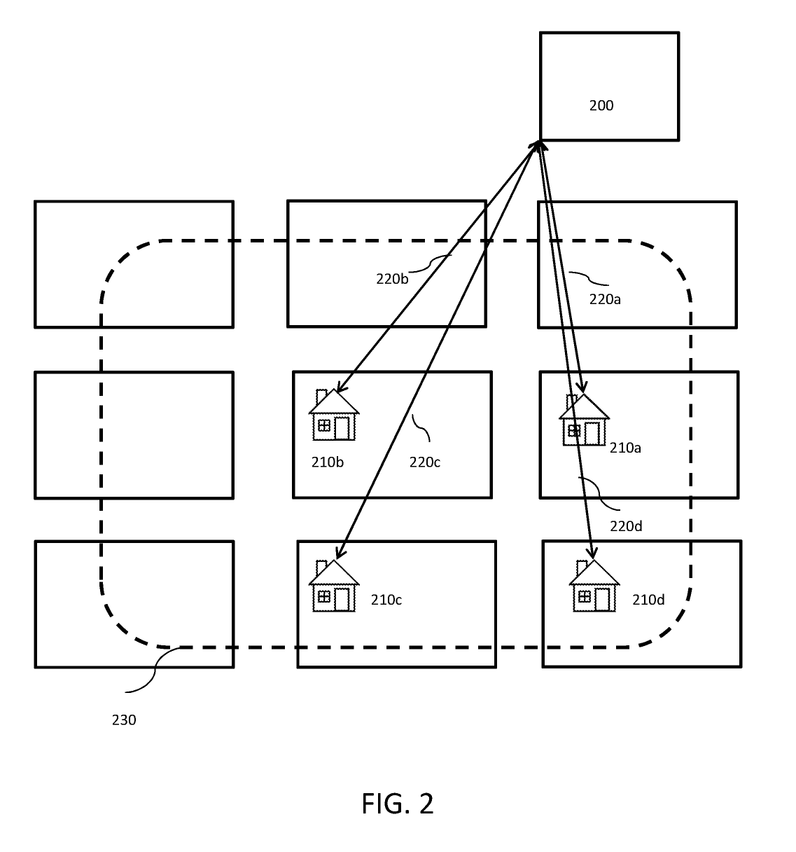

An overview of the neighborhood social networking system disclosed herein is detailed in FIG. 2. Neighborhood social networking system 200 connects neighbors located in residences 210a-d within geographical region 230. The neighbors 210a-d within geographical region 230 can communicate with one another via connections 220a-d, which are mediated by the neighborhood social networking service 200.

In this embodiment of a neighborhood social network, the geographical region is defined by a number of city blocks. I FIG. 2, the region bisects blocks on the periphery, but it is also possible to have the region follow streets or any other method for determining the boundary of the region.

Participation in the neighborhood social network can be via opt-in or opt-out. In the opt-in embodiment, each residence within the geographical region is made aware of the existence of the neighborhood social network, and the persons residing within the residence must affirmatively decide to be a part of the neighborhood social network in order to use the network or allow others within the network to contact them via the network. In the opt-out embodiment, each residence within the geographical region is added to the neighborhood social network automatically, and the persons residing with the residence must affirmatively decide to not be a part of the neighborhood social network.

Within the neighborhood social network, each resident who is part of the network can then use the network to communicate with other persons within the neighborhood social network. For example, a resident might wish to get rid of some furniture; if he or she places an advertisement on the internet or in a newspaper, he or she may have to wait for people to make appointments to see the furniture, and he or she may spend considerable amounts of time trying to arrange a viewing and sale. The same resident may wish to offer the furniture first to his or her immediate neighbors, and thereby avoid having to make arrangements to meet someone from across town. In addition, there would be less of a risk of theft or robbery from unscrupulous people posing as interested buyers, as the seller would instead be dealing with his neighbors that he or she already knows.

In addition to classified ads, residents may wish to offer services, or request services, such as a babysitter. Parents could arrange play-dates for their children within the neighborhood. Children could use the network to meet up with their friends within the neighborhood. Residents could inform neighbors of upcoming events—parties, movie nights, etc. Local businesses within the neighborhood could advertise, and offer targeted incentives to residents in the neighborhood. Residents could recommend local businesses to other residents in the neighborhood social network. In addition, the neighborhood social network could be used to alert the neighbors of an emergency, of a suspicious person in the neighborhood, or to be on the lookout for a missing cat or dog. And finally, a resident needing to borrow a cup of sugar could use the network to see if a neighbor was available to help.

In addition, the neighborhood social network may also include a bulletin-board, chat room, blog, or other functionality for communicating with the other residents in the neighborhood.

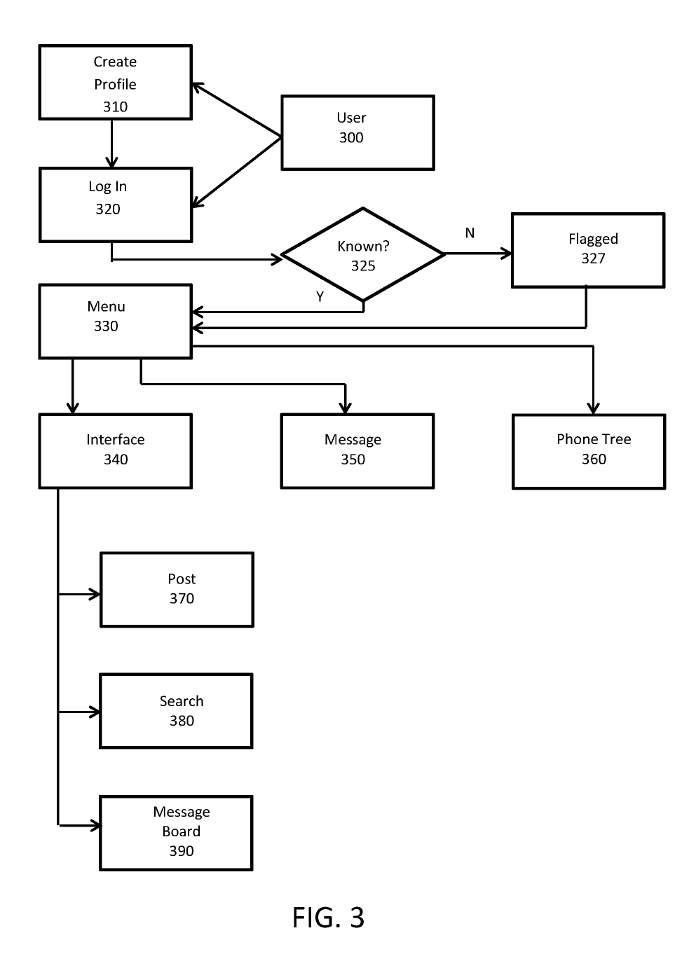

FIG. 3 details the steps of using the neighborhood social network. A user 300 is a person with access to the neighborhood social network. In the preferred embodiment, the user 300 is a resident of the neighborhood. In another embodiment, the user 300 may also be a guest of a resident.

Preferably, user 300 will create a profile 310 so that he or she can be identified by the other users of the neighborhood social network. In the preferred embodiment, the profile 310 includes the resident's name, address, and phone number. Other information, including personal information such as names of family members, names and information on pets, information on interests and hobbies, or any other information can also be included in the profile. Preferably the user will also create a username and password to protect the profile so that only he or she can log into the neighborhood social network using his or her profile. Preferably the profile 310 will also include a preferred method of contact, for example text, email, phone, etc.

Preferably, the user 300 logs into the social network using a computer, smart phone, or other device with a web browser. In the preferred embodiment, no password is needed to log into the neighborhood social network. If the user 300 has created a profile, and logs into the neighborhood social network using his or her profile, then the neighborhood social network will recognize the user 300 at 325, and will identify the user to other users 300 of the neighborhood social network by name.

If the user 300 does not have a profile, however, the user 300 can still log in to the system. The system will not recognize the user at 325, and will then flag the user 300 without a profile at 327. The flag will cause the system to identify the unknown user 300 as an unknown, unregistered user to other users 300 of the neighborhood social network.

In some embodiments, user profiles may be limited to permanent residents, and transient users may not be permitted to create a user profile. In other embodiments, the system may have guest accounts for transient users. If a user is using a guest account, the user would not be flagged as unknown as above, but will instead be flagged as a guest. In another embodiment, each residence may have a number of guest accounts associated with the residence for use by visitors of the residence. In this embodiment, a user of a guest account associated with a residence would still be flagged as a guest, but would also be identified as a guest of a particular residence.

This system increases access to the network while maintaining security. A transient resident, such as a temporary house guest of a permanent resident, can use the neighborhood social network to learn about the neighborhood without creating a profile. Because a user 300 without a profile will be flagged as unknown, other users 300 of the neighborhood social network are alerted to use higher levels of scrutiny when interacting with the unknown user 300.

In the preferred embodiment, once the user is either identified or flagged, the user is taken to the main portal 330 where the user can choose from a number of options. In the preferred embodiment, the user 300 would be able to choose from a web interface 340, a messaging interface 350, and a phone interface 360. In other embodiments, more or fewer options may be presented, and options other than those described in detail here may be implemented. Further, certain options may be disallowed for users 300 flagged as unknown.

The web interface 340 would preferably provide the user 300 with one or more options. Preferably, the options will include at least the posting information 370, searching information 380, and a message board 390. Posting information 370 would include creating an advertisement, an announcement, or any sort of communication or information to be shared with the neighborhood. Preferably, the posting would include the option to communicate the information with all or some of the residents in the neighborhood, the option to communicate by email, text, messaging, phone, or a combination, the option to post to a location on the web interface, and the option to prevent users flagged as unknown from viewing the post. For example, if a user decides to post an advertisement or recommendation for babysitting services, the user could choose to email and text the ad or recommendation to all of the residents of the neighborhood, or the user could choose to limit the communication of the ad to only those residents who have children.

Searching information 380 preferably would include the ability to perform keyword searches or guided searches of postings made on the web interface. In another embodiment, the searching information 380 could also include searching archived postings that were sent to residents, and could also include searching message board or bulletin board posts. Searching 380 preferably would also include a system for browsing the same information.

Message board 390 would preferably include at least a threaded messaging system that would allow users to leave messages and for other users to respond. In other embodiments, the message board 390 would also include one or more chat sessions for real-time communication, or could include a blog that on which one or more users could post materials. Preferably unknown users would be allowed to view threaded massages, but not reply to messages or leave their own messages, would be allowed to view blog postings, and would not be allowed into chat sessions.

Messaging interface 350 would preferably provide user 300 with the option to send a message to all, some or one of the neighborhood residents. Preferably the messaging interface would include the option to send a message using a built-in messaging system, sending an SMS or text, or sending an email, or a combination of thereof. The system could also send messages via a third-party system such as Twitter, Google Messaging, etc. The messaging interface 350 would allow the user 300 to enter the message, select recipients, select a message protocol, and send the message.

Phone interface 360 would preferably provide the user 300 with the option to either send a prerecorded message to some or all of the residents of the neighborhood, to initiate a live phone call to a resident, or to initiate a live conference call amongst some or all of the residents. Phone interface 360 would provide a mechanism by which the user 300 could record a message which would then be sent to the recipients.

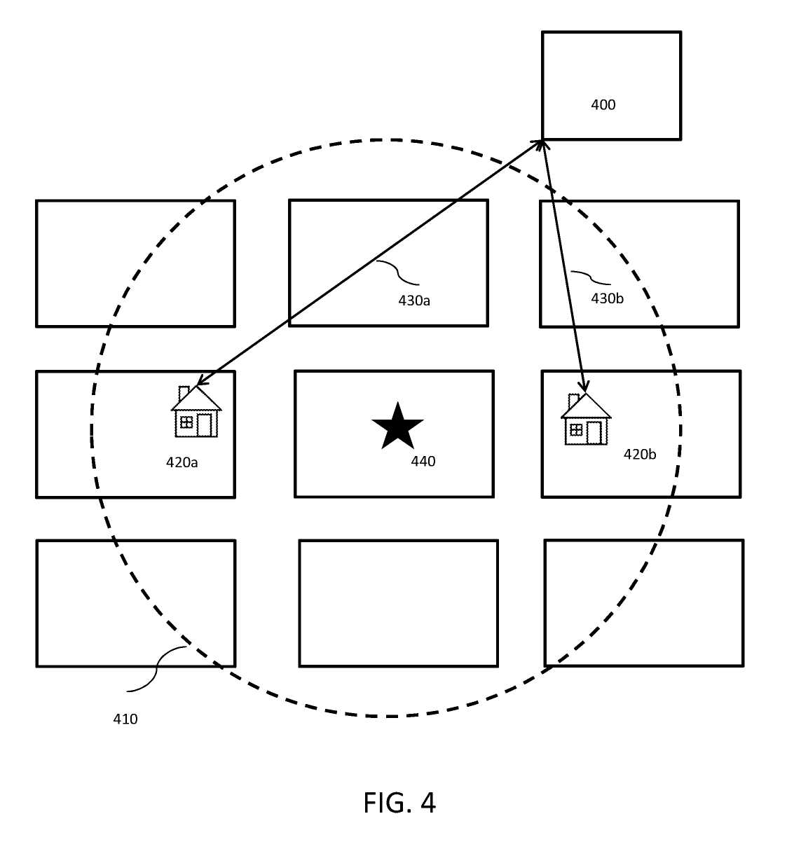

Another embodiment of the neighborhood social networking system disclosed herein is detailed in FIG. 4. Neighborhood social networking system 400 connects neighbors located in residences 420a and 420b within geographical region 410. The neighbors 420a and 420b within geographical region 410 can communicate with one another via connections 430a and 430b, which are mediated by the neighborhood social networking service 400.

In this embodiment of a neighborhood social network, the geographical region is defined by a circle with a defined radius centered on a particular point 440.

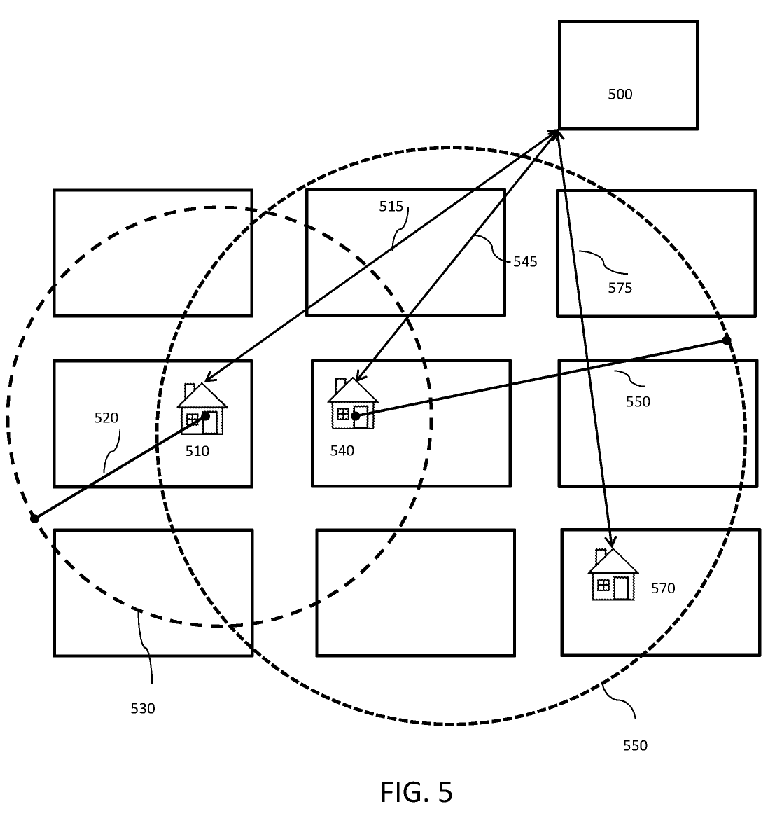

Another embodiment of the neighborhood social networking system disclosed herein is detailed in FIG. 5. Neighborhood social networking system 500 connects neighbors located in residences 510 and 540. In this embodiment, there are two geographical regions—geographical region 530 and geographical region 560. Geographical region 530 is a defined by a circle with a defined radius 520 centered on residence 510. Geographical region 560 is defined by a circle with a defined radius 550 centered on residence 540. Residence 510 and 540 can communicate with one another via connections 415 and 445, which are mediated by the neighborhood social networking service 500.

As described above with respect to FIGS. 2 and 4, residences within a particular geographical region can communicated with other residences in the same geographical region. In this example, geographical regions 530 and 560 overlap. Preferably, when an overlap occurs, a residence that is overlapped can communicate with residences in the other geographical region that is also overlapped. For example, in FIG. 5, residence 510 in geographical region 530 is overlapped by geographical region 560, and residence 540 in geographical region 560 is overlapped by geographical region 530, therefore residence 510 would be able to communicate with residence 550, even though they are in different geographical regions. However, residence 510 would not be able to communicate with residence 570, because residence 570 is not overlapped by geographical region 530. Residence 540 would be able to communicate with residence 570, because both are within geographical region 560.

In this embodiment, geographical region 530 is shown with radius 520 centered on residence 510, and geographical region 560 is shown with radius 550 centered on residence 540. In another embodiment, the radius 510 and radius 540 may be different. For example, in an embodiment, the users living in residence 510 may wish to interact with a smaller number of neighbors than the users living in residence 540, and therefore they could elect to make radius 520 smaller than radius 540. In another embodiment, the neighborhood social networking system may have a default setting, but users opting out of advertising on the system may be limited to a smaller radius, while users willing to pay a monthly fee may be allowed to have a much larger radius.

In another embodiment, either or both radii 520 and 540 may be changed dynamically. For example, if a user at residence 510 in geographical region 530 places an ad to sell a piece of furniture, the user may get no responses. Rather than place a citywide or region-wide add, in an embodiment the user could dynamically increase the radius of geographical region 530 to expose the ad to more potential buyers. Preferably the increase would be only for the particular ad, and preferably there would be a payment made to make a dynamic change to the geographical region.

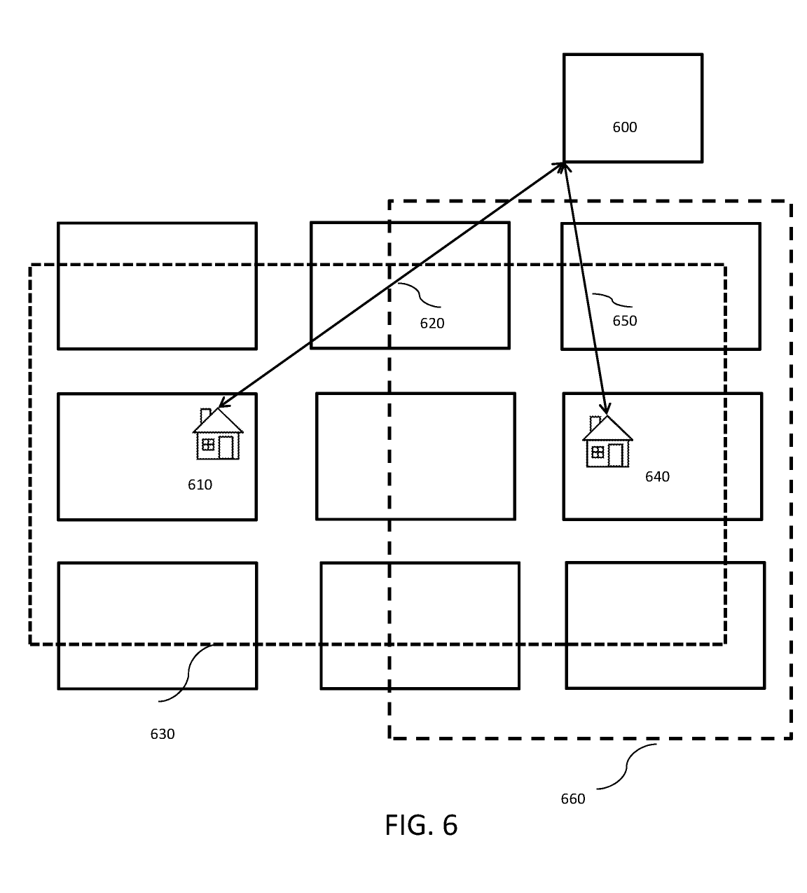

Another embodiment of the neighborhood social networking system disclosed herein is detailed in FIG. 6. Neighborhood social networking system 600 connects neighbors located in residences 610 and 640. In this embodiment, there are two geographical regions—geographical region 630 and geographical region 660. Geographical region 630 is a defined by a number of city blocks centered on residence 610. Geographical region 660 is defined by a number of city blocks centered on residence 640. Residence 610 and 640 can communicate with one another via connections 620 and 650, which are mediated by the neighborhood social networking service 600.

As described above with respect to FIGS. 5, geographical regions 630 and 660 overlap. Preferably, when an overlap occurs, a residence that is overlapped can communicate with residences in the other geographical region that is also overlapped. For example, in FIG. 6, residence 610 in geographical region 630 is overlapped by geographical region 660, and residence 640 in geographical region 660 is overlapped by geographical region 630, therefore residence 610 would be able to communicate with residence 650, even though they are in different geographical regions.

In this embodiment, geographical region 630 is shown as a group of city blocks centered on residence 610, and geographical region 660 is shown as a group of city blocks centered on residence 640. In another embodiment, the number of city blocks in geographical region 630 and geographical region 660 may be different. For example, in an embodiment, the users living in residence 610 may wish to interact with a smaller number of neighbors than the users living in residence 640, and therefore they could elect to make the number of blocks in geographical region 630 smaller than the number of blocks in geographical region 660. In another embodiment, the neighborhood social networking system may have a default setting, but users opting out of advertising on the system may be limited to a smaller radius, while users willing to pay a monthly fee may be allowed to have a much larger radius.

In another embodiment, the number of blocks in either geographical region 630 or 660 or both may be changed dynamically. Preferably the increase would be only for the particular ad, and preferably there would be a payment made to make a dynamic change to the geographical region.

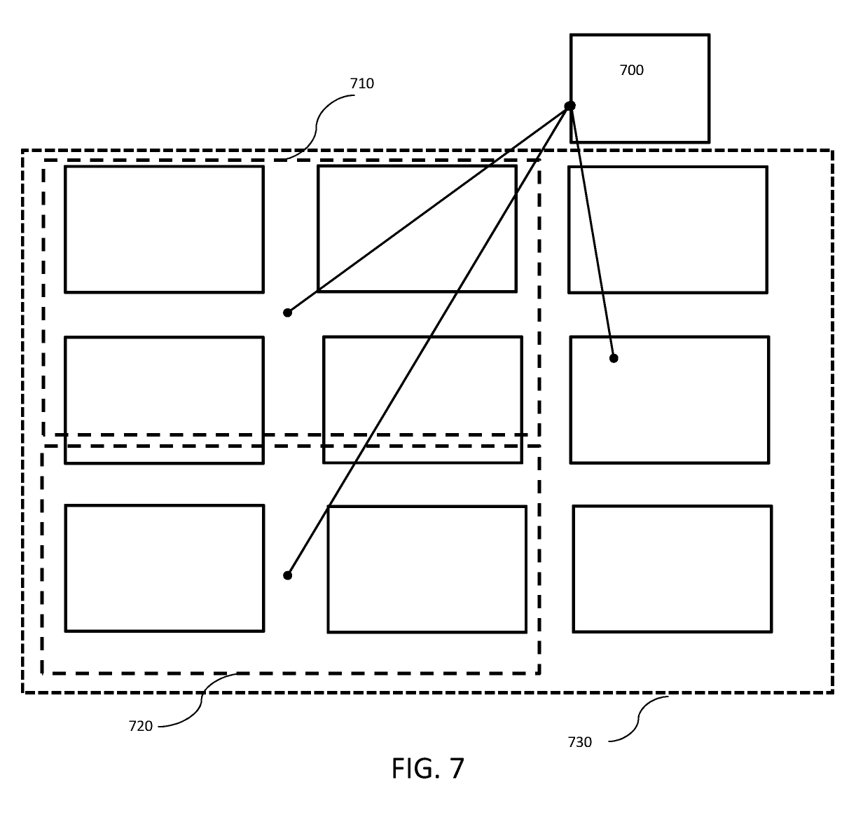

FIG. 7 illustrates an embodiment of a neighborhood social networking system where there are two types of users, residential users and business users. In FIG. 7, neighborhood social networking system 700 connects residential users residing in geographical region 710 to one another, and connects residential users residing in geographical region 720 to one another. In this embodiment, geographical regions 710 and 720 are separate and do not overlap, so residents of geographical region 710 would not be able to communicate via the neighborhood social networking system with residents of geographical region 720. In this embodiment, a second type of user, a business user, has a separate geographical region 730 that overlaps the two residential geographical regions 710 and 720.

Preferably, the business user in geographical region 730 can communicate with the residential users in geographical regions 710 and 720, and the residential users can communicate with the business user, as described more fully below.

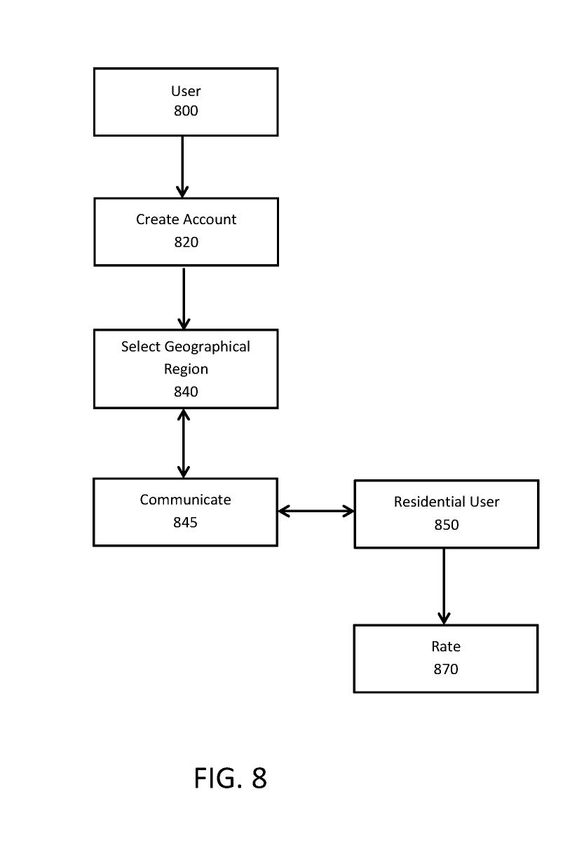

FIG. 8 details the steps of how business users and residential users can communicate. A business user 800 creates an account 820 with the neighborhood social network. The business user then decides how large its geographical region 840 should be. In one embodiment, the geographical region 840 is one or more residential geographical regions defined in accordance with other embodiments described herein. In another embodiment, the geographical region 840 is a circle with the business located at the center. In another embodiment, the geographical region 840 is a series of city blocks. In yet another embodiment, the geographical region 840 is a region of arbitrary size and shape.

Preferably, the business will be required to be located within the geographical region 840, or, for businesses with multiple locations or offices, have at least one location or office within the geographical region 840. Preferably, the system will charge the business user a fee based on the size of the selected geographical region 840.

Preferably, geographical region 840 will overlap one or more residential geographical regions. The business user 800 can communicate via the residential social network with residents 850 living in the geographical regions overlapped by geographical region 840. The business user 800 can communicate 860 advertisements, coupons, specials, etc., to the residential users 850.

Residential users 850 can, in turn, communicate 845 with business user 800 via the residential social network. Residential users 850 can make reservations, make special orders or requests, check inventory, complain, provide feedback, or any other communication. Preferably the business user 800 will create a portal or some other interface to allow residential users 850 to easily communicate 845 with the business user 800.

Preferably, the residential social networking system will also include a mechanism to allow residential users 850 to rate 870 the business user 800 in some fashion. Preferably the rating 870 will be visible only to the residential users 850. In another embodiment, the rating 870 will also be visible to the business user 800.

Preferably, the residential social networking system will also include a mechanism allowing residential users 850 to opt-out of communications with business users 800. The mechanism could allow a residential user 850 to opt-out of all communications with business users, or could allow a residential user 850 to limit communications to businesses that the residential user 850 is interested in. Preferably, if a residential user 850 opts out of some or all business communications, the user would not be able to see the ratings 870 associated with the businesses from which the residential user 850 has chosen to not receive communications. Alternatively, a fee could be levied against residential users 850 that choose not to receive any communications from any businesses.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, which are provided for purposes of illustration and not of limitation, and to the contrary, the present disclosure is to cover all modifications, equivalents, and alternatives.

What is claimed is:

1. A method for creating a geographically-defined social network, comprising:
defining the boundaries of a geographical area;
enabling a first user located within the defined boundaries of the geographical area to communicate across the geographically-defined social network with a second user located within the defined boundaries of the geographical area.

2. The method of claim 1 wherein the communication between the first user located within the defined boundaries of the geographical area and the second user located within the defined boundaries of the geographical area is by email.

3. The method of claim 1 wherein the communication between the first user located within the defined boundaries of the geographical area and the second user located within the defined boundaries of the geographical area is by SMS.

4. The method of claim 1 wherein the communication between the first user located within the defined boundaries of the geographical area and the second user located within the defined boundaries of the geographical area is by a messaging service.

5. The method of claim 1 wherein the communication between the first user located within the defined boundaries of the geographical area and the second user located within the defined boundaries of the geographical area is by phone.

6. The method of claim 1, wherein the geographical area is a plurality of city blocks.

7. The method of claim 1, wherein the geographical area is a circle of a defined radius.

8. The method of claim 1, wherein the geographical area is of an arbitrary size and shape.

9. The method of claim 1, wherein the location of the first user is the first user's residence.

10. The method of claim 1, wherein the location of the second user is the second user's residence.

11. The method of claim 1, further comprising:
defining the boundary of a first geographical area;
defining the boundary of a second geographical area; and
enabling a first user located within the defined boundaries of the second geographical area to communicate across the geographically-defined social network with a second user located within the defined boundaries of the first geographical area.

12. The method of claim 11, wherein the first geographical area is a circle of defined radius centered on the location of the first user, and the second geographical area is a circle of defined radius centered on the location of the second user.

13. The method of claim 12, wherein the defined radius of the first geographical area is different from the defined radius of the second geographical area.

14. The method of claim 11, wherein the first geographical area is a first plurality of city blocks centered on the location of the first user, and the second geographical area is a second plurality of city blocks centered on the location of the second user.

15. The method of claim 11, wherein the first geographical area is of an arbitrary size and shape centered on the location of the first user, and the second geographical area is of an arbitrary size and shape centered on the location of the second user.

16. A system for a geographically-defined social network, comprising:
a server;
a defined geographical area stored on the server;
a first user located within the defined geographical area;
a second user located within the defined geographical area; and
the server facilitating communications between the first user and the second user.

17. The system of claim 16 wherein the server-facilitated communication is email.

18. The system of claim 16 wherein the server-facilitated communication is SMS.

19. The system of claim 16 wherein the server-facilitated communication is a messaging service.

20. The system of claim 16 wherein the server-facilitated communication is a phone.

21. The system of claim 16, wherein the defined geographical area is a plurality of city blocks.

22. The system of claim 16, wherein the defined geographical area is a circle of a defined radius.

23. The system of claim 16, wherein the defined geographical area is of an arbitrary size and shape.

24. The system of claim 16, wherein the location of the first user is the first user's residence.

25. The system of claim 16, wherein the location of the second user is the second user's residence.

26. The system of claim 16, further comprising:
a defined first geographical area stored on the server; and
a defined second geographical area stored on the server;
wherein said first user is located within the defined second geographical area and said second user is location within the defined first geographical area.

27. The system of claim 26, wherein the defined first geographical area is a circle of defined radius centered on the location of the first user, and the defined second geographical area is a circle of defined radius centered on the location of the second user.

28. The system of claim 26, wherein the defined radius of the defined first geographical area is different from the defined radius of the defined second geographical area.

29. The system of claim 26, wherein the defined first geographical area is a first plurality of city blocks centered on the location of the first user, and the defined second geographical area is a second plurality of city blocks centered on the location of the second user.

30. The system of claim 26, wherein the defined first geographical area is an arbitrary size and shape centered on the location of the first user, and the defined second geographical area is an arbitrary size and shape centered on the location of the second user.
